(19) United States
(12) Patent Application Publication
(10) Pub. No.: US 2026/0054954 A1
(43) Pub. Date: Feb. 26, 2026

(54) BOOKLET MAKING APPARATUS AND IMAGE FORMING APPARATUS FOR MAKING BOOKLET BY USING TONER

(71) Applicant: CANON KABUSHIKI KAISHA, Tokyo (JP)

(72) Inventor: KENJI TAKAGI, Kanagawa (JP)

(21) Appl. No.: 19/303,131

(22) Filed: Aug. 18, 2025

(30) Foreign Application Priority Data
Aug. 20, 2024 (JP) 2024-139158

(51) Int. Cl. B65H 37/04; B42C 1/12; B42C 13/00

(52) U.S. Cl. CPC B65H 37/04; B42C 1/12; B42C 13/00; B65H 2301/51614

(57) ABSTRACT

A booklet making apparatus is manually fed and receives a sheet bundle constituted by a plurality of sheets having an adhesive layer of toner, executes heat processing for heating the adhesive layer in the sheet bundle, which has been manually fed into the receiving unit, and executes press processing for pressing the adhesive layer in the sheet bundle in parallel with the heat processing.

### BACKGROUND

### FIELD OF THE TECHNOLOGY

The present disclosure relates to a booklet making apparatus and an image forming apparatus for making a booklet by using toner.

### DESCRIPTION OF THE RELATED ART

Booklet making apparatuses make booklets by stapling a plurality of sheets, on which images have been printed, with a motorized stapler. However, metal staples hinder the recycling of booklets. Patent Document 1 proposes a post-processing apparatus that makes booklets by forming adhesive toner images on sheets together with images prepared by a user, and stacking, heating, and pressing the plurality of sheets (Japanese Patent Laid-Open No. 2014-237291).

In the related art, it is necessary to connect a post-processing apparatus that includes an alignment unit that aligns a sheet bundle and a thermocompression bonding unit that bonds the sheet bundle by thermocompression to an image forming apparatus that forms adhesive toner images on sheets. Therefore, booklet making apparatuses tend to become larger.

### SUMMARY

The present disclosure provides a booklet making apparatus comprising: a receiving unit configured to be manually fed and receive a sheet bundle constituted by a plurality of sheets having an adhesive layer of toner; a heating unit configured to execute heat processing for heating the adhesive layer in the sheet bundle, which has been manually fed into the receiving unit; and a pressing unit configured to execute press processing for pressing the adhesive layer in the sheet bundle in parallel with the heat processing by the heating unit.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an image forming apparatus.

FIGS. 2A to 2E are diagrams illustrating positions of adhesive toner images.

FIGS. 3A to 3E are diagrams illustrating a procedure of thermocompression bonding processing.

FIGS. 4A to 4H are diagrams illustrating a thermocompression bonding unit.

FIG. 5 is a diagram illustrating a controller.

FIG. 6 is a flowchart for explaining a control method.

FIGS. 7A to 7C are diagrams illustrating a problem of thermocompression bonding processing.

FIGS. 8A to 8D are diagrams illustrating a relationship between heating time and temperature.

FIG. 9 is a table for explaining an embodiment and comparative examples.

FIGS. 10A and 10B are diagrams illustrating a user interface.

FIGS. 11A to 11C are diagrams illustrating other positions of adhesive toner images.

FIGS. 12A to 12E are diagrams illustrating other positions of adhesive toner images.

FIGS. 13A to 13F are diagrams illustrating a procedure for making a booklet.

FIG. 14 is a flowchart for explaining a control method.

FIG. 15 is a diagram illustrating a user interface.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### 1. Image Forming Apparatus (Image Forming System)

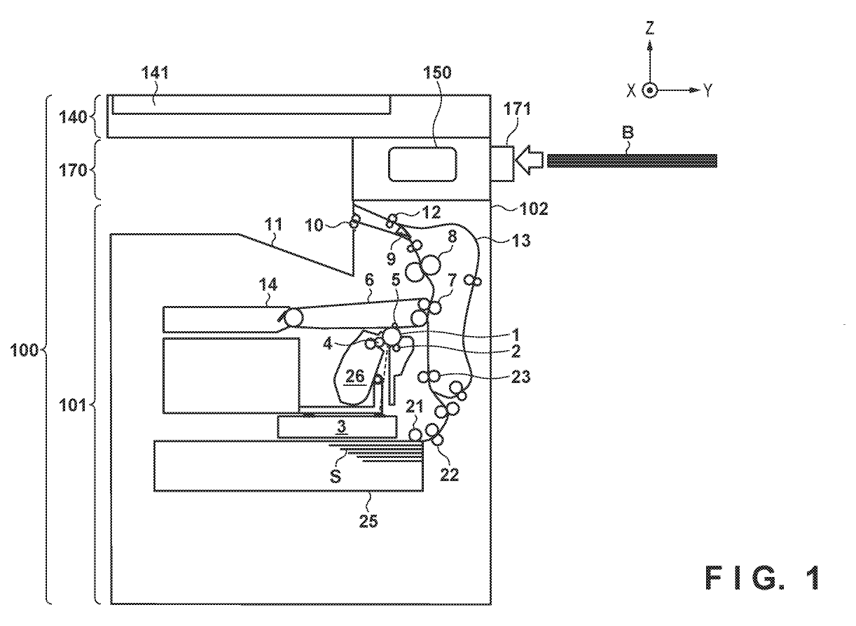

FIG. 1 is a schematic diagram of an image forming apparatus 100. A Z direction is a height direction of the image forming apparatus 100. An X direction is a depth direction. A Y direction is a width direction.

The image forming apparatus 100 includes a printer 101, a sheet processing unit 170, and a document reading apparatus 140. The printer 101 forms an image on a sheet S with toner. The printer 101 includes a housing 102. The sheet processing unit 170 makes a booklet by heating and pressing a sheet bundle B that is manually fed from an insertion port 171 by the user. The document reading apparatus 140 reads a document placed on a platen glass 141 and transmits an image signal that corresponds to the document to the printer 101. An operation unit 150 includes an input apparatus (e.g., a touch sensor and a button switch) and a display apparatus (e.g., a liquid crystal display).

In the printer 101, a photosensitive drum 1 is an image carrier that carries an electrostatic latent image and a toner image and rotates. A charger 2 is a charging roller or a charging wire that charges the surface of the photosensitive drum 1. An exposure apparatus 3 irradiates light corresponding to an image signal onto the surface of the photosensitive drum 1 to form an electrostatic latent image. A developing roller 4 develops the electrostatic latent image by using toner stored in a toner container 26 to form a toner image. A primary transfer roller 5 transfers the toner image from the photosensitive drum 1 to an intermediate transfer body 6. By the intermediate transfer body 6 rotating, the toner image is conveyed to a secondary transfer nip. The secondary transfer nip is formed by the intermediate transfer body 6 and a secondary transfer roller 7 coming into contact.

A feed roller 21 feeds a sheet S held in a sheet cassette 25 to a conveyance path. A separation roller pair 22 separates one sheet S from a plurality of sheets S and conveys the sheet S further downstream. Here, downstream is downstream in a conveyance direction of the sheet S. A registration roller 23 is a conveyance roller that corrects the skew of the sheet S and conveys the sheet S to the secondary transfer nip.

The secondary transfer roller 7 transfers the toner image from the intermediate transfer body 6 to the sheet S. A cleaning member 14 cleans the toner remaining on the intermediate transfer body 6. A fixer 8 includes a heating roller and a pressing roller, and applies pressure and heat to the sheet S and the toner image to fix the toner image onto the sheet S. A guide member 9 controls the destination of the sheet S. When discharging the sheet S to a discharge tray 11, the guide member 9 guides the sheet S to a discharge roller 10. The discharge roller 10 discharges the sheet S onto the discharge tray 11. In double-sided printing, the guide member 9 guides the sheet S to a reverse roller 12. The reverse roller 12 rotates forward to draw in the sheet S on which an image has been formed on a first side. The reverse roller 12 then rotates in reverse to feed the sheet S into a conveyance path 13. The sheet S is conveyed through the conveyance path 13 and reaches the secondary transfer nip again. The secondary transfer roller 7 transfers a toner image to a second side of the sheet S. The fixer 8 fixes the toner image onto the second side of the sheet S. The guide member 9 guides the sheet S to the discharge tray 11.

In FIG. 1, the sheet processing unit 170 is provided in the image forming apparatus 100, but the sheet processing unit 170 may be a stand-alone type booklet making apparatus or thermocompression bonding apparatus that is provided outside the image forming apparatus 100. In this case, the operation unit 150 functions as an operation unit of the sheet processing unit 170. The sheet processing unit 170 can concurrently execute heat processing and press processing for the sheet bundle B. Thermocompression bonding processing includes both heat processing and press processing.

The sheet S may be any of plain paper, thick paper, coated paper (paper subjected to surface processing), index paper, plastic film, cloth, envelope, and the like. Thus, the size, shape, and material of the sheet S are arbitrary.

### 2. Position of Adhesive Layer

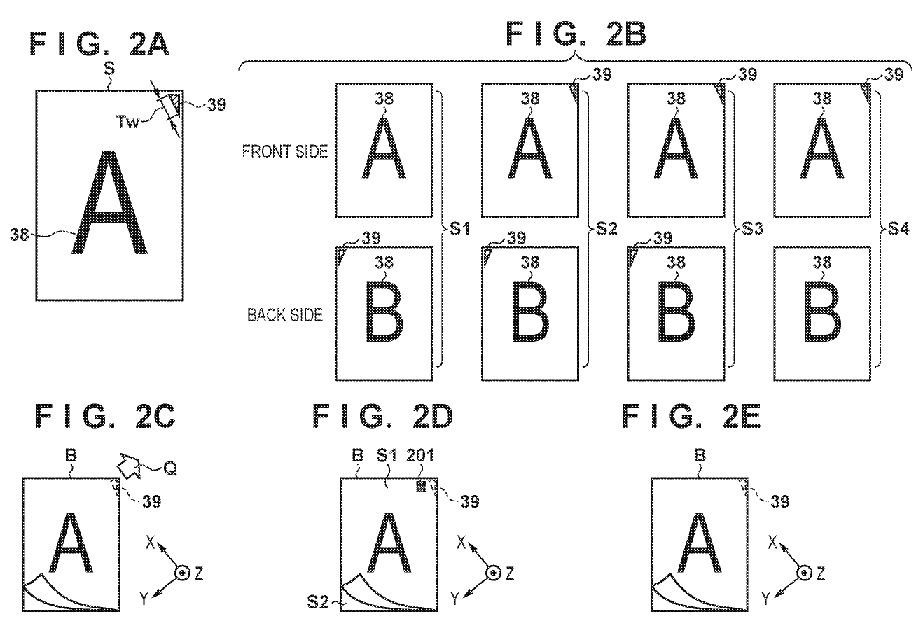

FIG. 2A illustrates an example of a toner image to be formed on a sheet S. A user image 38, such as text, a shape, or a photo, which is arbitrarily prepared by the user, and an adhesive layer (adhesive toner image 39) for bonding two adjacent sheets S are formed on the sheet S. In the first embodiment, the shape of the adhesive toner image 39 is a right triangle (three angles being 30°, 60°, and 90°, respectively). A width Tw of the hypotenuse of the adhesive toner image 39 is 25.0 mm. mm is an abbreviation for millimeter. The amount of toner per unit area (application amount) is 0.40 mg/cm^2. mg is an abbreviation for milligram. cm^2 is an abbreviation for square centimeters. These numbers are only one example. The position, shape, and size of the adhesive toner image 39 can be changed according to the structure of the sheet processing unit 170 and the size of the sheet S.

The sheet processing unit 170 can make a booklet that is constituted by a plurality of sheets S. FIG. 2B illustrates the front and back sides of four sheets S1 to S4 that form a booklet. The adhesive toner image 39 is formed except on the front cover (front side of the sheet S1) and the back cover (back side of the sheet S4) of the booklet. That is, the adhesive toner image 39 is formed on the back side of the sheet S1, both sides of the sheet S2, both sides of the sheet S3, and the front side of the sheet S4, respectively. Here, double-sided printing is assumed, but this is only one example. The adhesive toner image 39 may be formed only on one side of the sheets S.

FIG. 2C illustrates a sheet bundle B formed by the user manually aligning the plurality of sheets S1 to S4. The sheet bundle B is inserted into the sheet processing unit 170 along a Q direction and is subjected to thermocompression bonding processing. The Q direction is perpendicular to the hypotenuse of the right triangle adhesive toner image 39. The hypotenuse is parallel to the surface of the opening of the insertion port 171.

FIG. 2D illustrates that a barcode 201 is formed close to the adhesive toner image 39 of the sheet S1. The barcode 201 is an image or identification information indicating thermocompression bonding conditions (heating time, heating temperature, and material, size, thickness, whether the sheet S is coated) to be applied to the sheet bundle B. The document reading apparatus 140 may read the barcode 201 to decode or obtain the thermocompression bonding conditions. The barcode 201 is optional.

FIG. 2E illustrates a sheet bundle B for which thermocompression bonding processing has been completed. As will be described later, a booklet may be formed from a plurality of sheet bundles B.

### 3. Sheet Processing Unit

### 3-1. Procedure for Thermocompression Bonding Processing

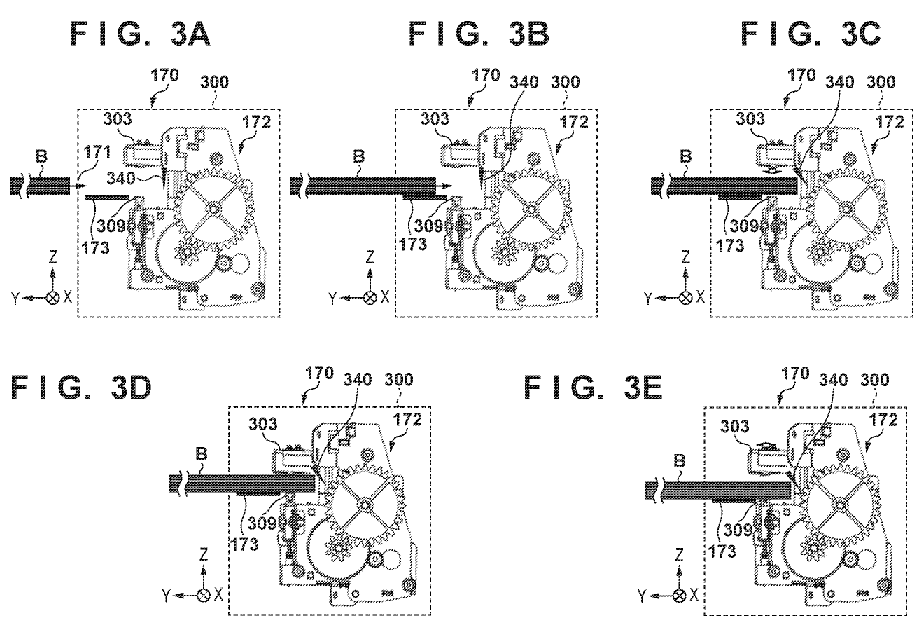

FIG. 3A illustrates the structure of the sheet processing unit 170. A thermocompression bonding unit 172 and a guide 173 are provided in a housing 300. The thermocompression bonding unit 172 executes thermocompression bonding processing on a sheet bundle B inserted by the user from the insertion port 171. The guide 173 receives the sheet bundle B inserted from the insertion port 171, supports the sheet bundle B, and guides the sheet bundle B to the thermocompression bonding unit 172. Thus, the insertion port 171 and the guide 173 function as a receiving unit.

The thermocompression bonding unit 172 includes a heater unit 303, a receiving component 309, and a sheet sensor 340. The heater unit 303 heats the adhesive toner images 39 of the sheet bundle B at a predetermined heating temperature. The heater unit 303 and the receiving component 309 can be moved relative to each other, and sandwich the sheet bundle B to press the sheet bundle B. That is, the heater unit 303 and the receiving component 309 cooperate to press the adhesive toner images 39 printed on the sheet bundle B. The heater unit 303 and the receiving component 309 function as a support member that supports the sheet bundle B and a pressing member that presses the sheet bundle B. The sheet sensor 340 is a sensor that detects that the sheet bundle B has been inserted into the thermocompression bonding unit 172. The sheet sensor 340 may be an optical sensor or an ultrasonic sensor.

As illustrated in FIG. 3B, the sheet bundle B is inserted into the thermocompression bonding unit 172 while being guided by the guide 173. As illustrated in FIG. 3C, by the leading end of the sheet bundle B rotating a flag of the sheet sensor 340, the sheet sensor 340 detects the sheet bundle B. For example, by the state of light directed from a light emitting element to a light receiving element included in the sheet sensor 340 changing due to the flag from a light shielded state to a light transmitting state (or from a light transmitting state to a light shielded state), the insertion of the sheet bundle B is detected. When the sheet sensor 340 detects the sheet bundle B, the thermocompression bonding unit 172 lowers the heater unit 303. As illustrated in FIG. 3D, the heater unit 303 presses the sheet bundle B and heats the adhesive toner images 39. When a predetermined heating time (may be referred to as pressing time, bonding time, or thermocompression bonding time) has elapsed, the heater unit 303 is raised, and the sheet bundle B can be removed from the thermocompression bonding unit 172. Then, the heater unit 303 stops at a standby position (home position). Since the heater unit 303 concurrently executes heat processing and press processing, the heating time and the pressing time are equal. Therefore, in the following, the heating time can be read as the pressing time. Further, the heating time is the time that the heater unit 303 is in contact with the sheet bundle B. Therefore, energization time during which power is supplied to the heater unit 303 is longer than the heating time. This is because the heater unit 303 is preheated in advance.

There is an upper limit to the number of sheets S to which thermocompression bonding processing can be applied at a time in the thermocompression bonding unit 172. For example, when the thickness of one sheet S is 0.1 mm, the upper limit of sheets S that form the sheet bundle B is 10. However, this is only one example.

In FIG. 3A to 3E, the thermocompression bonding processing is triggered by the sheet sensor 340 detecting the sheet bundle B, but this is only only example. The heater unit 303 may start the thermocompression bonding processing upon a press of a dedicated physical button provided in the operation unit 150, which is arranged in the vicinity of the sheet processing unit 170. Alternatively, the heater unit 303 may start the thermocompression bonding processing upon detection of a touch of a software button displayed on the operation unit 150.

The material of the heater unit 303 is a material with a low heat capacity. The time (preheating time) required from the start of heating until the heater unit 303 reaches the target temperature varies depending on the heat capacity of the heater unit 303. The heater unit 303 may start generating heat upon input of a job for the printer 101 to print the adhesive toner images 39 on sheets S. By starting to heat the heater unit 303 before the sheet bundle B is inserted into the sheet processing unit 170, the waiting time of the user after printing the sheets S is shortened.

As illustrated in FIG. 3D, a pressing position (contact position) at which the heater unit 303 presses the sheet bundle B in the Z direction varies depending on the thickness of the sheet bundle B. Therefore, if the pressing position is identified, the thickness of the sheet bundle B can be obtained. When the sheet bundle B is not inserted into the sheet processing unit 170, the heater unit 303 comes into direct contact with the receiving component 309. A position Zh0 of the heater unit 303 in the Z direction at this time is stored in advance in a memory of the printer 101. A position Zh1 of the heater unit 303 in the Z direction when the heater unit 303 contacts the sheet bundle B is measured. A position of the heater unit 303 in the Z direction can be obtained, for example, by counting the number of steps (number of pulses) of a stepping motor that moves the heater unit 303. A thickness ZhB of the sheet bundle B is a difference between Zh0 and Zh1. The thickness ZhB generally correlates with the heat capacity of the sheet bundle B to be heated by the thermocompression bonding unit 172. The pressing time may be increased in proportion to the thickness ZhB. Alternatively, the target temperature of a heater 304 may be increased in proportion to the thickness ZhB. Thus, the amount of heat for bonding the sheet bundle B with sufficient strength is ensured. Further, overheating of the sheet bundle B is prevented.

### 3-2. Structure of Thermocompression Bonding Unit

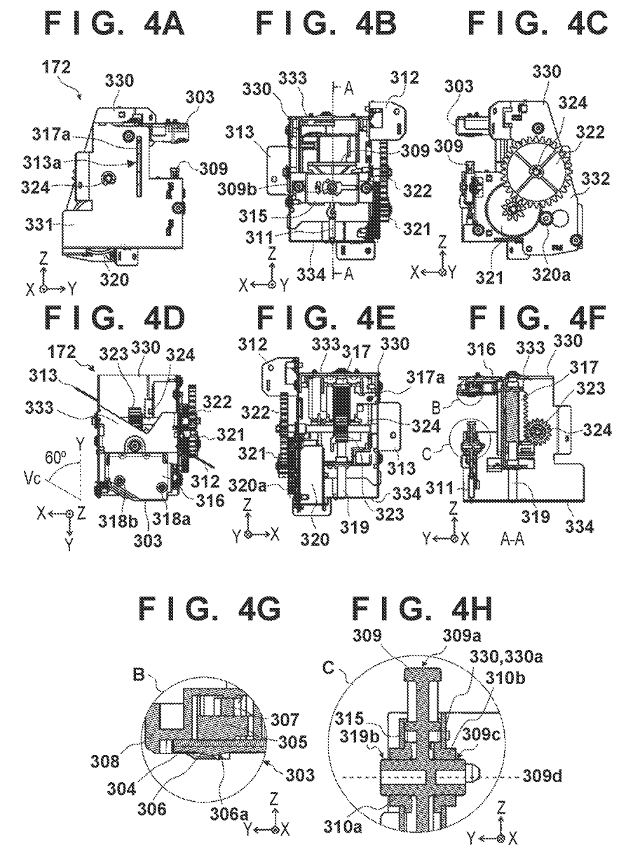

FIGS. 4A to 4H show a structure of the thermocompression bonding unit 172. The Z direction is a direction in which the pressing member moves relative to a receiving member to press the sheet bundle B, and is also a height direction (thickness direction) of the sheet bundle B. The directions perpendicular to each other in a virtual plane perpendicular to the Z direction are the X direction and the Y direction. As necessary, the X direction, the Y direction and the Z direction may be expressed as a +X side, a +Y side, and a +Z side, respectively, and their opposite directions may be expressed as a -X side, a -Y side, and a -Z side, respectively.

FIG. 4A is a left side view illustrating the thermocompression bonding unit 172 as viewed from the +X side. FIG. 4B is a front view illustrating the thermocompression bonding unit 172 as viewed from the +Y side. FIG. 4C is a right side view illustrating the thermocompression bonding unit 172 as viewed from the -X side. FIG. 4D is a plan view illustrating the thermocompression bonding unit 172 as viewed from the +Z side. FIG. 4E is a rear view illustrating the thermocompression bonding unit 172 as viewed from the -Y side. FIG. 4F is a cross-sectional view illustrating a cross section of the thermocompression bonding unit 172 along an A-A cutting line illustrated in FIG. 4B. FIG. 4G is an enlarged view of a region B in FIG. 4F. FIG. 4H is an enlarged view of a region C in FIG. 4F.

As illustrated in FIG. 4A, the thermocompression bonding unit 172 includes the heater unit 303, the receiving component 309, a main chassis 330, and a motor 320. The main chassis 330 constitutes a frame of the thermocompression bonding unit 172. The heater unit 303 is capable of reciprocal movement (capable of sliding) along the Z direction.

The thermocompression bonding unit 172 causes the heater unit 303 to move by using a driving force supplied by the motor 320, which is a driving source, to cause the heater unit 303 and the receiving component 309 to sandwich the sheet bundle B. Thus, the sheet bundle B and the adhesive toner images 39 are heated and pressed, and the plurality of sheets S included in the sheet bundle B are bonded.

The main chassis 330 includes a left side plate 331, a right side plate 332, a top plate 333, and a bottom plate 334. The left side plate 331 and the right side plate 332 are opposite each other in the X direction. The top plate 333 and the bottom plate 334 are opposite each other in the Z direction. As illustrated in FIG. 4B, a metal support plate 315 is fixed to the main chassis 330. As illustrated in FIG. 4H, the metal support plate 315 cooperates with a support 330a of the main chassis 330 to sandwich the receiving component 309 and thereby supports the receiving component 309. Thus, the receiving component 309 is positioned.

The main chassis 330 and the metal support plate 315 constitute the frame of the thermocompression bonding unit 172. The main chassis 330 includes attachment portions 312 and 313 for attaching the thermocompression bonding unit 172 to the housing 102 of the printer 101. That is, the thermocompression bonding unit 172 is attached to the housing 102 via the attachment portions 312 and 313. As illustrated in FIG. 1, the sheet bundle B is inserted from the insertion port 171 in the -Y direction into the thermocompression bonding unit 172. As illustrated in FIG. 2C, an insertion direction (-Y direction) of the sheet bundle B is skewed at 60° relative to the long side of the sheet bundle B in accordance with the adhesive toner images 39. Thus, the sheet bundle B is bound parallel to the hypotenuse of the adhesive toner images 39. As illustrated in FIG. 2E, one of the four corners of the sheet bundle B is bound and a corner bound booklet is made.

As illustrated by FIGS. 4D and 4F, the thermocompression bonding unit 172 includes an elevation stay 316, which can be moved relative to the main chassis 330. The elevation stay 316 is a metal plate component that holds the heater unit 303 and a rack gear 317. The heater unit 303 and the rack gear 317 are fixed to the elevation stay 316 by push nuts 318a and 318b, mechanical fasteners (not illustrated), and the like.

As illustrated in FIGS. 4C, 4E, and 4F, a driving system of the thermocompression bonding unit 172 includes the motor 320, a pinion gear 320a, gears 321, 322, and 323, and the rack gear 317. The driving system, which includes the motor 320, is an example of a pressing unit that presses the pressing member against the sheet bundle B. The motor 320 is a driving source for moving the heater unit 303 relative to the receiving component 309 and pressing a pressing plate 306 to the sheet bundle B. The pinion gear 320a, the gears 321, 322, and 323, and the rack gear 317 are a drive transmission mechanism that converts the rotation of the motor 320 into a moving direction (+Z direction/-Z direction) of the heater unit 303 and transmits it to the heater unit 303.

As illustrated in FIG. 4F, the rack gear 317 is guided by a cylindrical guide shaft 319, which extends parallel to the Z direction, and reciprocally moves parallel to the Z direction. Both ends of the guide shaft 319 are fixed to the main chassis 330. The heater unit 303 reciprocally moves parallel to the Z direction together with the rack gear 317 via the elevation stay 316.

As illustrated in FIG. 4A, the left side plate 331 of the main chassis 330 is formed with an elongated hole 313a, which is substantially parallel to the extension direction of the guide shaft 319. A rib 317a provided in the rack gear 317 is fitted into the elongated hole 313a. By the rib 317a being fitted into the elongated hole 313a, the rack gear 317 is positioned so as not to rotate around the guide shaft 319 (rotation stopping). The rib 317a and the elongated hole 313a are examples of a rotation stopping mechanism. Other rotation stopping mechanisms such as spline engagement may be employed.

The pinion gear 320a is attached to an output shaft of the motor 320. As illustrated in FIG. 4C, the gear 321 is a step gear, and has a large diameter gear portion and a small diameter gear portion. The large diameter gear portion of the gear 321 engages with the pinion gear 320a. The small diameter gear portion of the gear 321 engages with the gear 322. The gear 323 engages with the rack gear 317. The gear 323 is attached to a shaft 324 together with the gear 322. As illustrated in FIGS. 4A and 4C, the shaft 324 passes through the gears 322 and 323 and is rotatably supported by the left side plate 331 and the right side plate 332 of the main chassis 330. The gears 322 and 323 rotate together via the shaft 324. The pitch circle radius of the gear 323 is smaller than the pitch circle radius of the gear 322.

Thus, the driving force of the motor 320 is transmitted to the heater unit 303 via the pinion gear 320a, the gears 321, 322, and 323, and the rack gear 317, and the heater unit 303 slides parallel to the Z direction. The heater unit 303 moves (rises/lowers) in the +Z direction and the -Z direction according to the rotational direction of the motor 320.

The pinion gear 320a, the gears 321, 322, and 323, and the rack gear 317 constitute a speed reduction mechanism for obtaining the pressure necessary for bonding the sheet bundle B by thermocompression. As the speed reduction mechanism, for example, a worm gear or a planetary gear mechanism may be employed.

As illustrated in FIGS. 4F and 4G, the heater unit 303 includes the heater 304, the pressing plate 306, a thermoswitch 305, a compression spring 307, and a heater base 308.

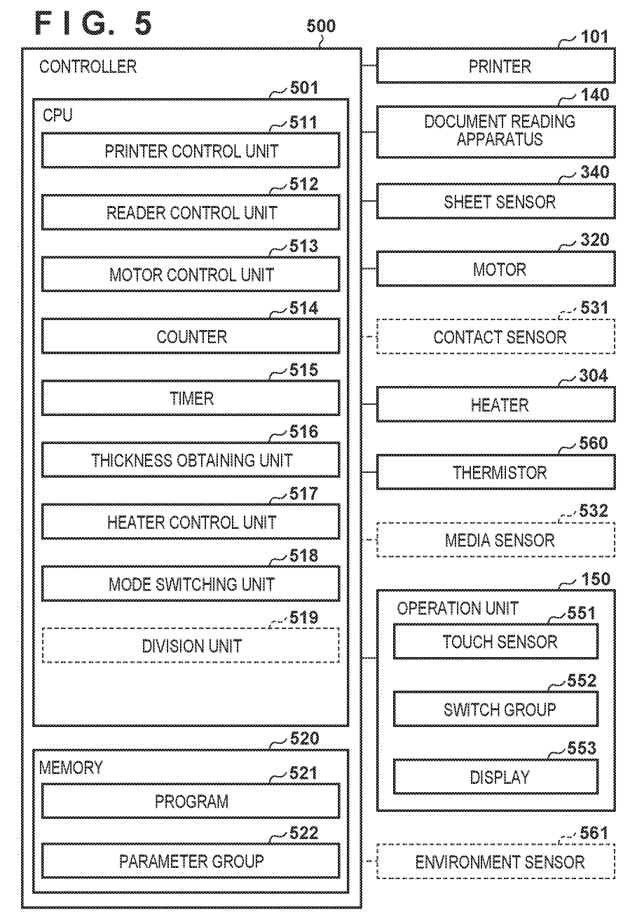

The heater 304 is an electrical component that heats the sheet bundle B to be bonded. The heater 304 may be a ceramic heater. The heater 304 may include, for example, a 1-mm thick insulator substrate made of alumina. A heating circuit that includes a heating resistor and a temperature detection circuit (thermistor 560 of FIG. 5) may be formed on the insulator substrate. The insulator substrate is a plate that extends in the X direction and the Y direction, with the Z direction as the thickness direction. A first side (surface on the -Z side) of the insulator substrate comes into contact with the pressing plate 306. The heating circuit and the thermistor 560 are mounted on a second side (surface on the +Z side) of the insulator substrate. When power is supplied to the heating circuit, heat propagates from the heating circuit to the pressing plate 306 via the insulator substrate, and the temperature of the pressing plate 306 increases. The material of the pressing plate 306 may be, for example, an aluminum material with rigidity and thermal conductivity (1.5 mm thick). The power supplied to the heating circuit is controlled such that the temperature detected by the thermistor 560 is the target temperature (e.g., 210 °C). Thus, the surface temperature of the pressing plate 306 is adjusted to 200 °C.

The pressing plate 306 is a pressing member for sandwiching and pressing the sheet bundle B in cooperation with the receiving component 309, which serves as the receiving member. The material of the pressing plate 306 is, for example, a 3-mm thick, heat resistant silicone rubber. As illustrated in FIG. 4G, one surface (surface on the -Z side) of the two surfaces of the pressing plate 306 is a contact surface 306a, which contacts the sheet bundle B. At least part of the contact surface 306a may have a convex shape protruding in the -Z direction. The contact surface 306a may be a convex portion extending in the X direction. The convex portion of the contact surface 306a, for example, may have an arced, curved surface when viewed in the X direction. The pressure when the sheet bundle B is pressed by the convex portion is, for example, about 1.0 MPa.

The thermoswitch 305 is an example of a safety apparatus. When abnormal heating occurs due to an abnormality or the like of a control system, the thermoswitch 305 detects abnormal heating, and physically cuts the connection between the heating circuit and the power supply to stop the supply of power to the heating circuit.

The compression spring 307 is arranged between the heater base 308 and the thermoswitch 305. The heater base 308 holds the heater 304, the pressing plate 306, the thermoswitch 305, and the compression spring 307. The heater base 308 is held in the elevation stay 316.

The pressing plate 306 is fixed to the heater base 308. The heater 304, the thermoswitch 305, and the compression spring 307 are sandwiched between the pressing plate 306 and the heater base 308. The biasing force of the compression spring 307 presses the thermoswitch 305 and the heater 304 against the pressing plate 306. Thus, the heat of the heater 304 is efficiently propagated to the pressing plate 306.

As illustrated in FIGS. 4F and 4H, the sheet processing unit 170 includes the receiving component 309, which is an example of the receiving member. The receiving component 309 includes a contact surface 309a, which contacts the sheet bundle B on one side (+Z side) in the Z direction. The receiving component 309 is opposite the pressing plate 306 of the heater unit 303 in the Z direction. The contact surface 309a of the receiving component 309 and the contact surface 306a of the pressing plate 306 are opposite in the Z direction. The contact surface 309a and the contact surface 306a overlap when viewed from the Z direction. However, two elements overlapping when viewed from a given direction refers to a case where, when each element is projected perpendicularly to a virtual plane perpendicular to that direction, a projection region of one element and a projection region of the other element at least partially overlap.

The contact surface 309a of the receiving component 309 is a long and thin rectangle extending in the X direction. Further, in a state in which the pressure from the pressing plate 306 is not applied, the contact surface 309a is substantially planar (flat).

As illustrated in FIG. 4H, the receiving component 309 includes shaft portions 309b and 309c, which extend in a direction that intersects (e.g., a direction perpendicular to) the Z direction. The receiving component 309 includes the shaft portion 309b, which projects in the +Y direction, and the shaft portion 309c, which projects in the -Y direction. The shaft portion 309b is rotatably supported by a bearing 310a. The shaft portion 309c is rotatably supported by a bearing 310b. The shaft portions 309b and 309c are examples of a shaft portion that extends in a first direction and allows the receiving member to tilt about the shaft portion (first shaft portion). The bearing 310a is attached to the metal support plate 315, which is fixed to the main chassis 330. The bearing 310b is attached to the support 330a of the main chassis 330.

The receiving component 309 can be tilted such that the contact surface 309a tilts about an axial line 309d, which extends in the Y direction. The receiving component 309 is positioned in the Y direction by being sandwiched between the metal support plate 315 and the support 330a of the main chassis 330. The receiving component 309 needs to have a stiffness that withstands the pressure from the pressing plate 306. Therefore, the receiving component 309 may have a both-end support configuration in which it is supported at both ends in a direction of the axial line 309d.

As illustrated in FIGS. 4B and 4F, the receiving component 309 is biased by a tension spring 311. The tension spring 311 is engaged with a hook portion of the receiving component 309 and biases the hook portion in the -Z direction. The position at which the moment applied to the receiving component 309 by the biasing force of the tension spring 311 becomes 0 in rotation directions about the axial line 309d is a neutral position (reference position) of the receiving component 309. When the receiving component 309 rotates from the neutral position in either rotation direction, the biasing force of the tension spring 311 applies a moment on the receiving component 309 that tries to return it to the neutral position.

The contact surface 309a of the receiving component 309 is designed, for example, such that the contact surface 309a does not tilt when the receiving component 309 is in the neutral position. The contact surface 309a not tilting means that the contact surface 309a is substantially perpendicular to the Z direction when viewed from the axial line 309d direction (Y direction).

The tension spring 311 is an example of a biasing unit that biases the receiving component 309. If the position of the hook portion relative to the axial line 309d is changed, the arrangement of the tension spring 311 is also changed. A torsion coil spring, or a resilient member such as rubber, for example, may be employed in place of the tension spring 311. The present disclosure is not limited those using an elastic force, and a magnet that biases the receiving component 309 by a magnetic force or a weight that biases the receiving component 309 by gravity may be employed.

### 4. Toner

Toner is, for example, toner containing thermoplastic resin as a main component. However, this is only one example. Known thermoplastic resins such as polyester resin, vinyl-based resin, acrylic resin, styrene-acrylic resin, polyethylene, polypropylene, polyolefin, ethylene-vinyl acetate copolymer resin, and ethylene-acrylic acid copolymer resin may be employed. The toner may contain a plurality of resins among these resins.

The toner may further contain wax. Wax includes, for example, ester wax which is an ester from alcohol and acid, or hydrocarbon-based wax, such as paraffin wax, for example.

The toner may include a black colorant. The toner may contain a magnetic substance, a charge control agent, wax, and an external additive.

### 5. Controller

FIG. 5 illustrates a controller 500 of the image forming apparatus 100. A central processing unit (CPU) 501 controls the printer 101, the document reading apparatus 140, and the sheet processing unit 170 according to a program 521 and a parameter group 522 stored in a ROM area of a memory 520. The CPU 501 realizes a plurality of functions, some or all of which may be realized by another hardware circuit (e.g., an application-specific integrated circuit (ASIC)). ROM is an abbreviation for read-only memory. The memory 520 is a storage apparatus that may include, in addition to a random access memory (RAM), a hard disk drive (HDD), a solid state drive (SSD), or the like.

The operation unit 150 includes a touch sensor 551 and a switch group 552, which function as an input apparatus. The switch group 552 may have a button for instructing the start of bonding processing in the sheet processing unit 170. The operation unit 150 includes a display 553, which functions as a display apparatus and an output apparatus. The display 553 may assist the user by displaying a guidance message indicating how to use the sheet processing unit 170 or the like.

A printer control unit 511 controls the printer 101 in accordance with a print job and causes the printer 101 to form an image on the sheet S. A reader control unit 512 controls the document reading apparatus 140 to cause the document reading apparatus 140 to read a document and generates an image signal or image data corresponding to the document.

A motor control unit 513 controls forward rotation and reverse rotation of the motor 320 to lower and raise the heater unit 303. A contact sensor 531 detects that the contact surface 306a of the heater unit 303 has come into contact with a sheet bundle B. When the contact sensor 531 detects that the contact surface 306a has come into contact with the sheet bundle B, the motor control unit 513 stops the motor 320. When the contact surface 306a comes into contact with the sheet bundle B, a timer 515 measures a predetermined heating time. Upon expiration of the predetermined heating time, the motor control unit 513 starts reverse rotation of the motor 320 to return the heater unit 303 to the standby position. The standby position may be referred to as an initial position or a home position. A counter 514 counts the number of driving pulses (driving amount) inputted to the motor 320 in a period in which the contact surface 306a is moved from the standby position to the contact position. A count value corresponds to above Zh1, which is used to obtain the thickness of the sheet bundle B. Zh1 corresponds to the driving amount of the motor 320 in a period from when the pressing plate 306 is in the initial position until it comes into contact with the sheet bundle B.

A thickness obtaining unit 516 obtains the thickness ZhB of the sheet bundle B based on the measurement result (e.g., Zh1) of the counter 514 and the initial value (e.g., Zh0) stored in the memory 520. The thickness obtaining unit 516 may calculate the thickness ZhB of the sheet bundle B based on the thickness of the sheet S that is obtained by a media sensor 582 provided in the conveyance path of the printer 101 and the number of sheets S that form the sheet bundle B. The number of sheets S that form the sheet bundle B may be inputted via the operation unit 150. A grammage (g/cm^2) of the sheet S may be inputted via the operation unit 150 or the media sensor 582 as necessary. The thickness obtaining unit 516 may calculate the thickness ZhB based on the thickness and the number of sheets S that are inputted via the operation unit 150.

A heater control unit 517 determines a combination of the target temperature and the heating time of the heater 304 based on the number of sheets S that form the sheet bundle B and the grammage of the sheet S. The target temperature and the heating time may be inputted via the operation unit 150. The heater control unit 517 may adjust the target temperature and the heating time based on the temperature and humidity detected by an environment sensor 561. This is because a combination of an appropriate target temperature and heating time varies depending on the initial temperature of the sheets S (ambient temperature) and the amount of moisture contained in the sheets S. The parameter group 522 may hold a combination of a target temperature and a heating time that corresponds to a combination of humidity and temperature. When a heating start condition is satisfied, the heater control unit 517 starts supplying power to the heater 304. The heater control unit 517 controls power such that the temperature detected by the thermistor 560 approaches the target temperature. The heating start condition is, for example, that the sheet sensor 340 detects the sheet bundle B or the printer 101 starts forming an image on the sheet S. The thermistor 560 may be referred to as a temperature sensor.

A mode switching unit 518 selects one control mode from a plurality of control modes provided to control the sheet processing unit 170. For example, there may be a plurality of different control modes corresponding to the thickness ZhB of the sheet bundle B. Furthermore, there may be a control mode for separating a sheet S from the sheet bundle B by reheating the sheet bundle B. The mode switching unit 518 executes switching of the control mode based on the thickness ZhB obtained by the thickness obtaining unit 516 or an instruction inputted from the operation unit 150. The parameter group 522 stored in the memory 520 includes a combination of a target temperature and a heating time for each control mode. The parameter group 522 may include a threshold for switching the control mode. The parameter group 522 may include a table or function for adjusting the target temperature and the heating time based on ambient temperature and ambient humidity. A division unit 519 is optional and will be described in a second embodiment.

### 6. Flowchart

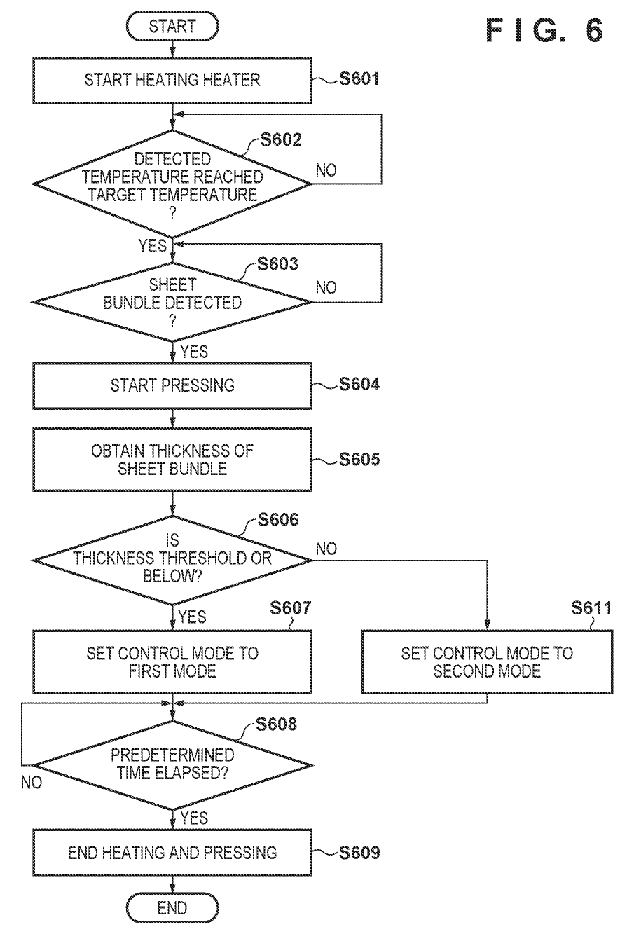

FIG. 6 illustrates a method of controlling the sheet processing unit 170 that is executed by the CPU 501 in accordance with the program 521. Here, it is assumed that an instruction to start thermocompression bonding processing has been input by the user via the operation unit 150.

In step S601, the CPU 501 (heater control unit 517) starts to heat the heater 304 by supplying power to the heater 304.

In step S602, the CPU 501 (heater control unit 517) detects the temperature of the heater 304 by using the thermistor 560, and determines whether the detected temperature has reached the target temperature. When the detected temperature reaches the target temperature, the CPU 501 proceeds from step S602 to step S603.

In step S603, the CPU 501 determines whether the sheet bundle B has been detected by the sheet sensor 340. When the sheet bundle B is detected by the sheet sensor 340, the CPU 501 proceeds from step S603 to step S604.

In step S604, the CPU 501 (motor control unit 513) starts pressing of the pressing plate 306. The motor control unit 513 causes the motor 320 to rotate forward and thereby lowers the pressing plate 306. The heater unit 303 is moved in the -Z direction together with the pressing plate 306. When the pressing plate 306 comes into contact with the sheet bundle B, the timer 515 starts measuring a predetermined time.

In step S605, the CPU 501 (thickness obtaining unit 516) obtains the thickness ZhB of the sheet bundle B. The thickness obtaining unit 516 calculates the thickness ZhB based on the lowering amount of the pressing plate 306 measured by the counter 514 (the number of pulses of the motor 320), for example.

In step S606, the CPU 501 (mode switching unit 518) determines whether the thickness ZhB is a threshold or below. The threshold is, for example, 0.55 mm.

If the thickness ZhB is the threshold or below, the CPU 501 proceeds from step S606 to step S607. In step S607, the CPU 501 sets the control mode to a first mode and proceeds from step S607 to step S608. If the thickness ZhB exceeds the threshold, the CPU 501 proceeds from step S606 to step S611. In step S611, the CPU 501 sets the control mode to a second mode and proceeds from step S611 to step S608.

In step S608, the CPU 501 determines whether a predetermined time has elapsed from a pressing start time based on the time measured by the timer 515. When the predetermined time elapses, the CPU 501 proceeds from step S608 to step S609.

In step S609, the CPU 501 ends heating and pressing. The heater control unit 517 ends the supply of power to the heater 304. The motor control unit 513 causes the motor 320 to rotate in reverse and thereby returns the pressing plate 306 to the standby position.

### 7. Thermocompression Bonding Conditions (Heating Conditions)

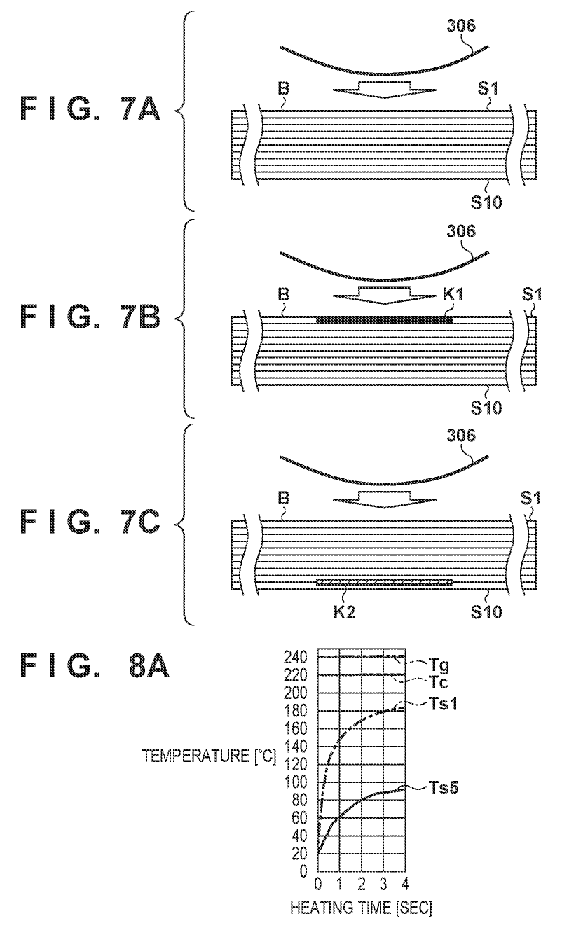

FIGS. 7A to 7C illustrate thermocompression bonding processing on a sheet bundle B formed from ten sheets S1 to S10 by the thermocompression bonding unit 172. As illustrated in FIG. 7A, the sheet S1 is in an uppermost position of the sheet bundle B. The sheet S10 is in the lowermost position of the sheet bundle B.

FIG. 7B indicates a problem that arises when the sheet bundle B is overheated. The sheet bundle B is heated by heat supplied from the pressing plate 306. The pressing plate 306 comes into contact with the sheet S1 of the sheet bundle B. Therefore, the temperature of an upper portion of the sheet S1 tends to become the highest. When an upper portion K1 of the sheet S1 is overheated, the sheet S1 may thermally degrade and become discolored (yellow). This phenomenon may be referred to as color change. According to studies of the inventors, it has been found that in order to reduce color change, the temperature of the upper portion of the sheet S1 need only be a predetermined temperature (e.g., 190 °C) or below.

FIG. 7C indicates a problem caused by insufficient heating. The sheet S10 is positioned farthest from the pressing plate 306. The upper portion of the sheet S10 tends to become the most heat deficient. If insufficient heating occurs in a portion K2 of the sheet S10, toner does not sufficiently fuse, and the adhesive strength decreases. According to studies of the inventors, it has been found that in order to ensure sufficient adhesive strength, the temperature of the upper portion of the sheet S10 need only be 90 °C or above and 110 °C or below. These numbers are only one example.

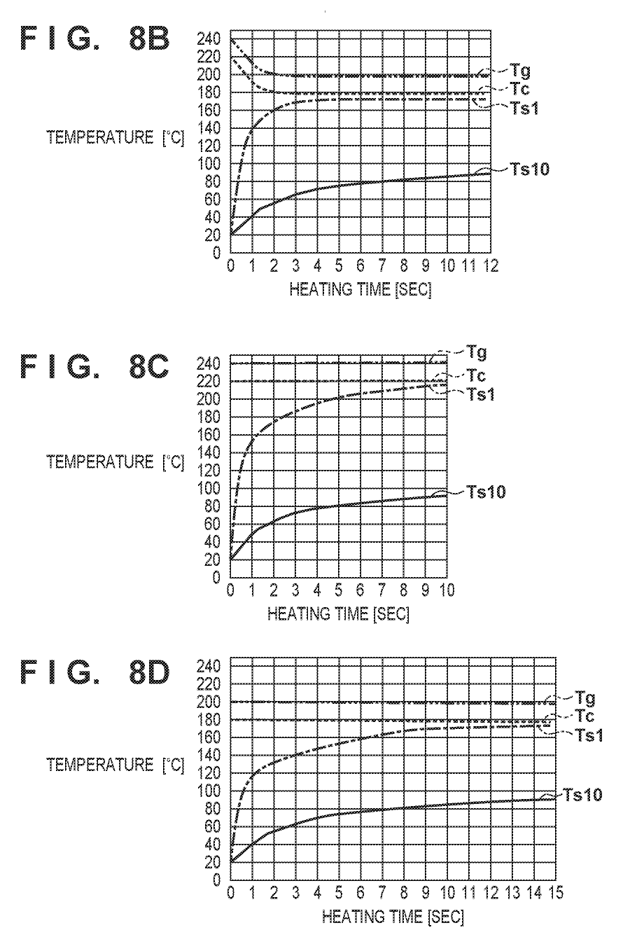

FIG. 8A is a diagram illustrating a relationship between heating time and temperature in the first mode. FIG. 8B is a diagram illustrating a relationship between heating time and temperature in the second mode. The horizontal axis indicates time. The vertical axis indicates temperature. Tg is the target temperature of the heater 304. Tc is the surface temperature of the pressing plate 306. Ts1 is the temperature of the sheet S1. Ts5 is the temperature of the fifth sheet S5. Ts10 is the temperature of the tenth sheet S10. The sheets S1 to S10 are A4-sized sheets called GF-C081 manufactured by Canon Inc.

If the thickness ZhB of the sheet bundle B is a threshold (e.g., 0.55 mm) or below, the first mode is employed. The target temperature of the heater 304 is set to 240 °C. As illustrated in FIG. 8A, the sheet bundle B may be formed by five sheets S1 to S5. In order for the temperature Ts5 of an upper portion of the sheet S5 to reach a bondable temperature (e.g. 90 °C), 4 seconds of heating time is necessary. The temperature Ts1 of the sheet S1 increases to 185℃ by 4 seconds of heating. Therefore, no color change occurs in the sheet S1.

Meanwhile, when the thickness ZhB of the sheet bundle B exceeds the threshold, the second mode is selected. The target temperature Tg of the heater 304 gradually transitions from 240°C to 200°C. As illustrated in FIG. 8B, the sheet bundle B may be formed from ten sheets S1 to S10. In order for the temperature Ts10 of the sheet S10 to reach a bondable temperature (e.g. 90 °C), 12 seconds of heating time is necessary. In the first few seconds of the 12 seconds, the target temperature Tg of the heater 304 transitions from 240 °C to 200 °C. The temperature Tc of the pressing plate 306 also decreases. The temperature Ts1 of the sheet S1 increases to 175 ℃. Therefore, no color change occurs in the sheet S1.

Here, the threshold for the thickness ZhB is an upper limit of the thickness at which the bonding processing can be completed without causing a color change, while keeping the target temperature Tg at a high temperature. The threshold may be determined by the CPU 501 depending on the structure of the sheet processing unit 170, the target temperature, the grammage and material of the sheet S, the properties of adhesive toner, and the toner application amount of the adhesive toner image 39.

FIG. 8C illustrates a first comparative example. The sheet bundle B is formed from sheets S1 to S10. The target temperature Tg is maintained at 240 °C (constant). In order for the temperature Ts10 of the sheet S10 of the first comparative example to reach a bondable temperature, 10 seconds of heating time is necessary. In the 10 seconds, the temperature Ts1 of the sheet S1 reaches 215 °C. Therefore, a color change may occur in the sheet S1.

FIG. 8D illustrates a second comparative example. The sheet bundle B is formed from sheets S1 to S10. The target temperature Tg is maintained at 200 °C (constant). In order for the temperature Ts10 of the sheet S10 of the second comparative example to reach a bondable temperature, 15 seconds of heating time is necessary. Since the target temperature Tg is 200 °C, the heating time increases. However, since the temperature of the sheet S1 is kept at 175 °C, no color change occurs. Thus, by lowering the temperature of the heater 304 and the pressing plate 306, color change and bonding failure are less likely to occur, but the heating time becomes longer.

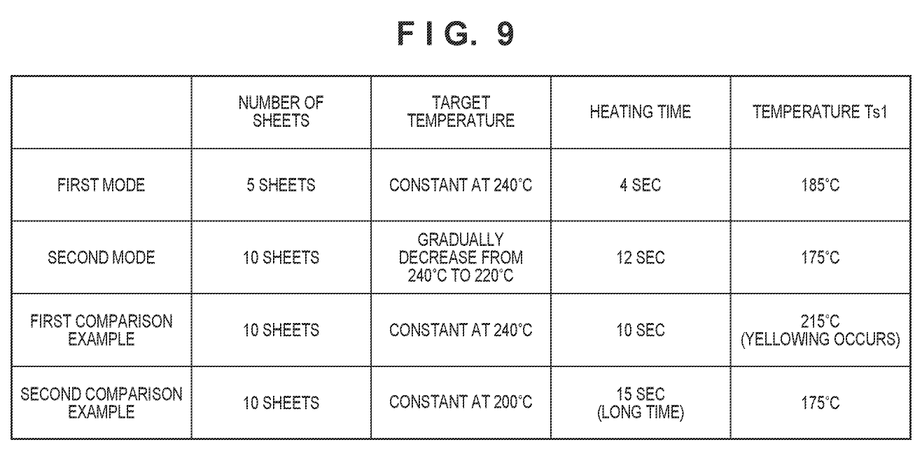

FIG. 9 is a table indicating test results from FIGS. 8A to 8D. As illustrated in FIG. 9, when the number of sheets S is small, by setting the first mode as the control mode, the heating time is shortened, no color change occurs, and sufficient adhesive strength is achieved. When the number of sheets S is large, by setting the second mode as the control mode, an increase in heating time is prevented, no color change occurs, and sufficient adhesive strength is achieved.

Thus, in the first mode, the heating temperature of the heater 304 is kept constant at a first target temperature during a first heating time. In the second mode, the heating temperature of the heater 304 may gradually transition from the first target temperature to a second target temperature during the second heating time and is then kept constant at the second target temperature. That is, the heating temperature transitions from the first target temperature to the second target temperature at the beginning of the second heating time, and is kept constant in the remaining period of the second heating time.

As another method of setting thermocompression bonding conditions (target temperature and heating time), the barcode 201 illustrated in FIG. 2D, for example, may be used. The CPU 501 (reader control unit 512) causes the document reading apparatus 140 to read the barcode 201 printed on the sheet S1 and decodes identification information from the barcode 201. The CPU 501 obtains thermocompression bonding conditions that correspond to the identification information from the parameter group 522. Here, the identification information may be associated with the number of sheets S that form the sheet bundle B, the thickness of one sheet S, the grammage of the sheet S, or the like. In this case, the CPU 501 may calculate the target temperature and the heating time by substituting the number of sheets S, the thickness of one sheet S, or the grammage of the sheet S into a predetermined equation.

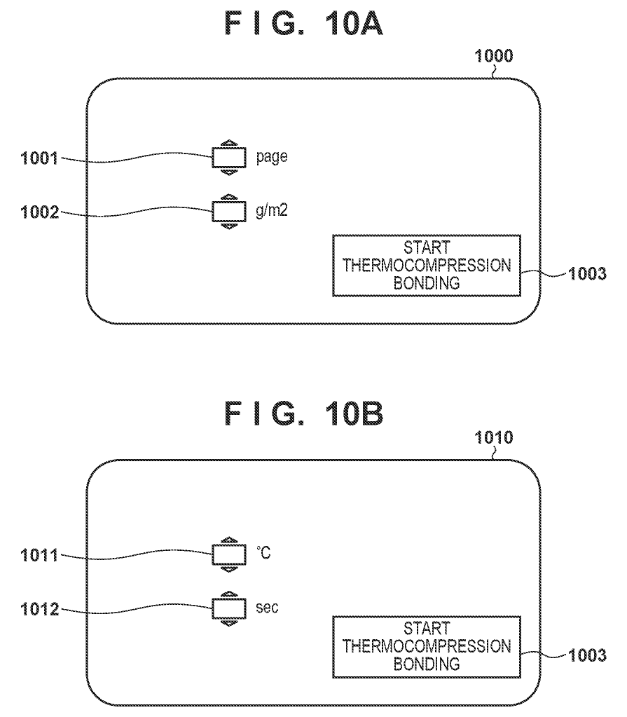

FIG. 10A illustrates a setting screen 1000 to be displayed on the display 553. The setting screen 1000 includes an accepting portion 1001, which accepts input of the number of sheets S that form the sheet bundle B, and an accepting portion 1002, which accepts input of a grammage. The CPU 501 may calculate the target temperature and the heating time based on the number and the grammage. The setting screen 1000 may include a start instruction button 1003 for the user to instruct the start of thermocompression bonding processing.

FIG. 10B illustrates a setting screen 1010 to be displayed on the display 553. The setting screen 1010 includes an accepting portion 1011, which accepts input of target temperature, and an accepting portion 1012, which accepts input of heating time. Thus, the heating time and the target temperature may be inputted by the user. The setting screen 1010 may also include the start instruction button 1003.

### 8. Others

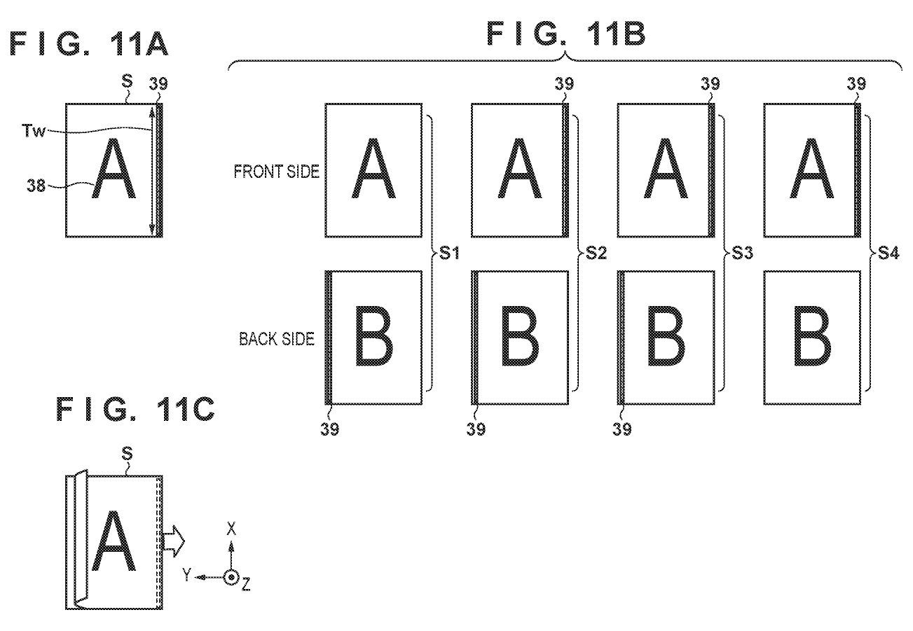

As illustrated in FIG. 2A, the adhesive toner image 39 is formed at one corner of the four corners of the sheet S, but this is only one example of a corner bound booklet. As illustrated in FIG. 11A, the adhesive toner image 39 may be formed on a long side of the sheet bundle B. Thus, a long-side bound booklet is made. The adhesive toner image 39 may be formed on a short side of the sheet bundle B. Thus, a short-side bound booklet is made. Since the adhesive toner image 39 is printed in parallel with the long side or the short side, the width Tw is equal to or slightly shorter than the length of the long side or the length of the short side.

FIG. 11B illustrates the front and back sides of four sheets S1 to S4 that form a booklet. The adhesive toner image 39 is formed except on the front cover (front side of the sheet S1) and the back cover (back side of the sheet S4) of the booklet. That is, the adhesive toner image 39 is formed on the back side of the sheet S1, both sides of the sheets S2 and S3, and the front side of the sheet S4, respectively. Here, double-sided printing is assumed, but this is only one example. The adhesive toner image 39 may be formed only on one side of the sheet S.

FIG. 11C illustrates a sheet bundle B formed by the user aligning the plurality of sheets S1 to S4. The sheet bundle B is inserted into the sheet processing unit 170 along the -Y direction and is subjected to thermocompression bonding processing.

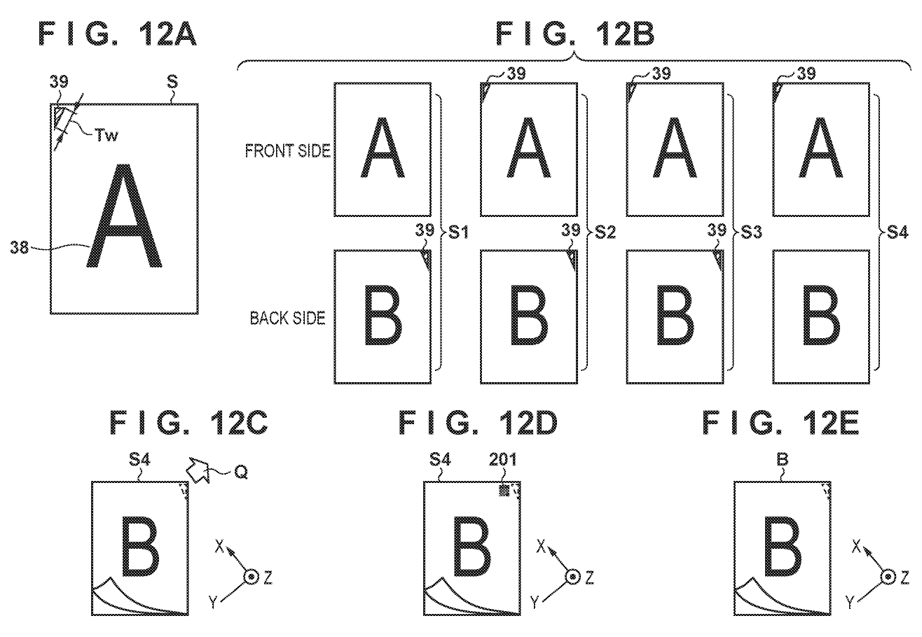

As illustrated in FIG. 12A, the adhesive toner image 39 may be formed on an upper-left corner of the sheet S. FIG. 12B illustrates the front and back sides of four sheets S1 to S4 that form a booklet. The adhesive toner image 39 is formed except on the front cover (front side of the sheet S1) and the back cover (back side of the sheet S4) of the booklet. That is, the adhesive toner image 39 is formed on the back side of the sheet S1, both sides of the sheets S2 and S3, and the front side of the sheet S4, respectively. Here, double-sided printing is assumed, but this is only one example. The adhesive toner image 39 may be formed only on one side of the sheet S.

FIG. 12C illustrates a sheet bundle B formed by the user aligning the plurality of sheets S1 to S4. The sheet bundle B is inserted into the sheet processing unit 170 along the Q direction and is subjected to thermocompression bonding processing. Since the adhesive toner image 39 is formed on the upper-left corner of the sheet S, the sheet bundle B is inserted into the sheet processing unit 170 such that the sheet S4 is in the uppermost position. As illustrated in FIG. 12D, the barcode 201 may be formed on the back side of the sheet S4. This is because the back side of the sheet S4 is a side that is easy for the user to see. As illustrated in FIG. 12E, an upper-left bound booklet is completed.

By replacing the images formed on respective sheets, upper-left binding illustrated in FIGS. 12A to 12E becomes upper-right binding. In this case, the front side of the sheet S1 is the back cover of the booklet. The back side of the sheet S4 is the front cover of the booklet. When instructed to make an upper-right bound booklet, the CPU 501 determines the position of the adhesive toner image 39 to be in one of the four corners. However, by changing the orientation and order in which the images are formed in accordance with the position of the adhesive toner image 39, the CPU 501 realizes an upper-right bound booklet regardless of which corner the adhesive toner image 39 is formed.

When always binding only right-side bound booklets, surfaces that correspond to the upper-right corner of the sheet S among the surfaces of components (e.g., the photosensitive drum 1, the developing roller 4, the intermediate transfer body 6, and the belt cleaner) of the printer 101 will become increasingly worn out. However, by changing the position of the adhesive toner image 39 by the method illustrated in FIGS. 12A to 12E, wear of components involved in image formation is reduced. That is, uneven deterioration among components is reduced, and it is possible to extend component lifespan. Thus, the CPU 501 may change the position of the adhesive layer (adhesive toner image 39) each time a predetermined number of sheet bundles B are formed. The predetermined number may be 1, 2, or more.

### Second Embodiment

In the first embodiment, one booklet is made from one sheet bundle B. In the second embodiment, one booklet is made from N sheet bundles B. The total number of sheets S that form the booklet is J sheets. The number (predetermined number) of sheets S for which an increase in heating time is prevented, no color change occurs, and sufficient adhesive strength is achieved in one thermocompression bonding process is K sheets. In the second embodiment, matters in common with the first embodiment are given the same reference numerals, and description thereof will be omitted.

### 1. Method of Making Booklet

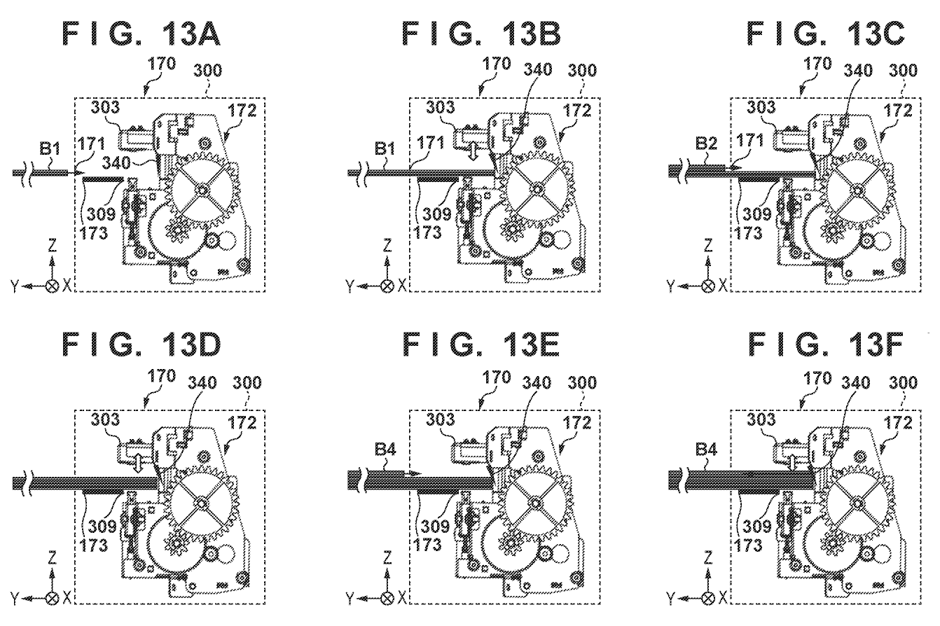

FIGS. 13A to 13F illustrate a method of making a booklet by the sheet processing unit 170 according to the second embodiment. Here, one booklet is made by stacking four sheet bundles B1 to B4 in order. When using index i, an i-th sheet bundle B is denoted as Bi. As illustrated in FIG. 13A, a first sheet bundle B1 is inserted into the sheet processing unit 170. As illustrated in FIG. 13B, when the sheet sensor 340 detects the sheet bundle B1, the sheet processing unit 170 executes the thermocompression bonding processing on the sheet bundle B1. Here, it is assumed that the first mode described in the first embodiment is applied.

As illustrated in FIG. 13C, a second sheet bundle B2 is inserted into the sheet processing unit 170 while the sheet bundle B1 remains in the sheet processing unit 170. As illustrated in FIG. 13D, the sheet processing unit 170 executes the thermocompression bonding processing while the sheet bundle B2 is on the sheet bundle B1. A third sheet bundle B3 is stacked on the sheet bundle B2 while the sheet bundles B1 and B2 remain in the sheet processing unit 170. The sheet processing unit 170 executes the thermocompression bonding processing on the sheet bundles B1 to B3.

As illustrated in FIG. 13E, the last sheet bundle B4 is inserted from the insertion port 171 and stacked on the sheet bundle B3. As illustrated in FIG. 13F, the sheet processing unit 170 executes the thermocompression bonding processing while the sheet bundle B4 is on the sheet bundle B3. Thus, a booklet constituted by the sheet bundles B1 to B4 is formed.

In order to bond a plurality of sheet bundles B, the number of surfaces of sheets S on which the adhesive toner image 39 is formed increases. The adhesive toner image 39 is formed on each of the front side of the sheet S in the uppermost position in the i-th sheet bundle Bi and the back side of the sheet S in the lowermost position in the i + 1-th sheet bundle Bi + 1. The sheet bundle Bi + 1 is stacked on the sheet bundle Bi.

### 2. Calculation of Division Number

The CPU 501 (division unit 519) obtains a division number N from the total number J inputted by the user and the predetermined number K. If the total number J is 16 and the predetermined number K is 4, the division number N is 4. If the total number J is 12 and the predetermined number K is 4, the division number N is 3. If the total number J is 7 and the predetermined number K is 4, the division number N is 2.

### 3. Flowchart

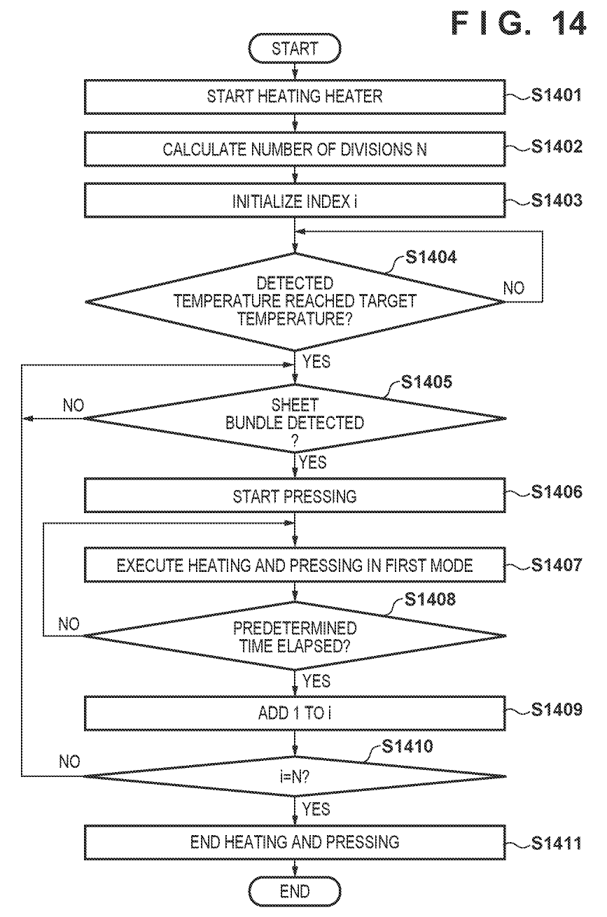

FIG. 14 illustrates a method of controlling the sheet processing unit 170 that is executed by the CPU 501 in accordance with the program 521. Here, it is assumed that the user has instructed to start thermocompression bonding processing via the operation unit 150.

In step S1401, the CPU 501 (heater control unit 517) starts to heat the heater 304 by supplying power to the heater 304.

In step S1402, the CPU 501 (division unit 519) calculates the division number N, which is a quotient, by dividing the total number J by the predetermined number K. In step S1403, the CPU 501 initializes the index i for counting or identifying the sheet bundle B. The initial value of i is 0.

In step S1404, the CPU 501 (heater control unit 517) detects the temperature of the heater 304 by using the thermistor 560, and determines whether the detected temperature has reached the target temperature. When the detected temperature reaches the target temperature, the CPU 501 proceeds from step S1404 to step S1405.

In step S1405, the CPU 501 determines whether the sheet bundle B has been detected by the sheet sensor 340. When the sheet bundle B has been detected by the sheet sensor 340, the CPU 501 proceeds from step S1405 to step S1406.

In step S1406, the CPU 501 (motor control unit 513) starts pressing of the pressing plate 306. The motor control unit 513 causes the motor 320 to rotate forward and thereby lowers the pressing plate 306. The heater unit 303 is moved in the -Z direction together with the pressing plate 306. When the pressing plate 306 comes into contact with the sheet bundle B, the timer 515 starts measuring a predetermined time.

In step S1407, the CPU 501 (heater control unit 517) sets the control mode to the first mode and executes heating and pressing on the sheet bundle Bi in the first mode.

In step S1408, the CPU 501 determines whether a predetermined time has elapsed from a pressing start time based on the time measured by the timer 515. When the predetermined time elapses, the CPU 501 proceeds from step S1408 to step S1409.

In step S1409, the CPU 501 adds 1 to the index i. In step S1410, the CPU 501 determines whether the index i equals the division number N. This determination is equivalent to determining whether the booklet has been completed. Alternatively, this determination corresponds to determining whether thermocompression bonding processing has been completed for all the sheet bundles B. If thermocompression bonding processing has not been completed for all the sheet bundles B, the CPU 501 proceeds from step S1410 to step S1405 and waits for the next sheet bundle B to be inserted into the sheet processing unit 170. If thermocompression bonding processing has been completed for all the sheet bundles B, the CPU 501 proceeds from step S1410 to step S1411.

In step S1411, the CPU 501 ends heating and pressing. The heater control unit 517 ends the supply of power to the heater 304. The motor control unit 513 causes the motor 320 to rotate in reverse and thereby returns the pressing plate 306 to the standby position.

In the second embodiment, by repeating the thermocompression bonding processing N times, a booklet formed by stacking N sheet bundles B is completed. As compared with the first embodiment, in the second embodiment, the number of sheets S that form one sheet bundle B may be small. Thus, the amount of heat applied by the thermocompression bonding unit 172 to the sheet bundle B is reduced, and the risk of color change is reduced. Furthermore, it is possible to make a booklet formed from more sheets S.

### Third Embodiment

In the first and second embodiments, the sheet processing unit 170, which performs thermocompression bonding processing on the sheet bundle B, has been described. Here, an adhesive for bonding two adjacent sheets S is toner. As described above, toner is remelted or softened when heated. Therefore, when thermocompression bonding processing is performed again on the sheet bundle B subjected to thermocompression bonding processing, the adhesive toner image 39 is softened. Thus, the user can separate the plurality of sheets S that form the sheet bundle B. In the third embodiment, a detach mode (third mode) for separating or detaching a plurality of sheets S is described.

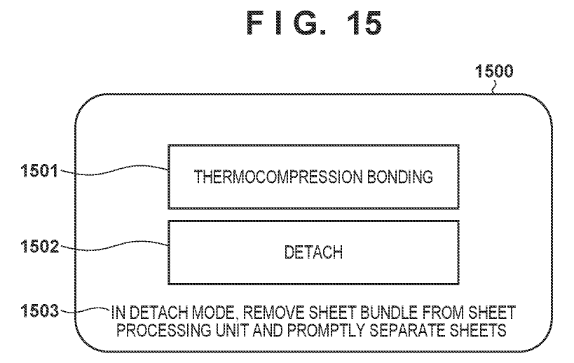

FIG. 15 illustrates a selection screen 1500 to be displayed on the display 553. The selection screen 1500 includes a button 1501 for instructing the start of thermocompression bonding processing, and a button 1502 for instructing the start of detach processing. The CPU 501 detects a button that has been pressed or touched by the user among the buttons 1501 and 1502 via the touch sensor 551.

In the first and second embodiments, a combination of the target temperature and the heating time of the heater unit 303 is determined such that the temperature of the adhesive toner image 39 of the sheet S in a position farthest from the heater unit 303 in the sheet bundle B becomes 90 °C. In the third embodiment, a combination of the target temperature and the heating time of the heater unit 303 is determined such that the temperature of the adhesive toner image 39 of the sheet S in a position farthest from the heater unit 303 in the sheet bundle B becomes 130 °C. That is, when the button 1502 is pressed, the mode switching unit 518 switches the control mode to the detach mode. The mode switching unit 518 obtains the target temperature (e.g., 260 °C) for the detach mode and the heating time from the parameter group 522 and sets the target temperature in the heater control unit 517 and the heating time in the timer 515. Thus, it is possible to detach the sheet S. The heating time of the detach mode (third mode) may be set to be longer than the heating time of the first mode or the like.

When the thermocompression bonding unit 172 reheats the sheet bundle B, the user needs to promptly detach the sheet S from the sheet bundle B. As such, the selection screen 1500 may include a guidance message 1503 on the detach mode for the user.

In the third embodiment, a method of detaching the sheet S from the bonded sheet bundle B has been described. That is, it becomes possible to return a plurality of bonded sheets S to being a plurality of non-bonded sheets S.

### Others

A sheet bundle constituted by a plurality of sheets that have adhesive layers of toner is manually fed into the insertion port 171, and the insertion port 171 receives the sheet bundle. The heater 304 executes heat processing for heating the adhesive layers in the sheet bundle manually fed into the insertion port 171. The pressing plate 306 and the receiving component 309 execute press processing for pressing the adhesive layers in the sheet bundle in parallel with the heat processing by the heater 304. Thus, a booklet making apparatus that has a simple configuration is provided.

The start instruction button 1003 accepts an instruction to start bonding processing for a sheet bundle. This allows the user to manually instruct the start of thermocompression bonding processing.

The sheet sensor 340 detects a sheet bundle that has been manually fed into the insertion port 171. This allows the user to save the effort of pressing the start instruction button 1003.

The thickness obtaining unit 516, the document reading apparatus 140, the media sensor 532, and the operation unit 150 obtain the thickness of a sheet bundle. When the thickness of the sheet bundle is a threshold (e.g., 0.5 mm) or below, the CPU 501 controls the heater 304 to the first target temperature (e.g., 240 °C) and controls the heating time of the sheet bundle to a first time (e.g., 4 seconds) (first mode). When the thickness of the sheet bundle exceeds the threshold, the CPU 501 controls the heater 304 to the second target temperature (e.g., 200 °C) and controls the heating time of the sheet bundle to a second time (e.g., 12 seconds) (second mode). Thus, the control mode according to the thickness of the sheet bundle B is applied.

The CPU 501 reheats adhesive layers in the sheet bundle, which has been bonded by toner, by using the heater 304 so as to make sheets detachable from the sheet bundle (third mode). In the third mode, the heater 304 is controlled to the third target temperature (e.g., 260 °C). This allows the user to use the booklet making apparatus as a sheet detaching apparatus.

The thermocompression bonding processing is repeatedly executed while stacking a plurality of sheet bundles B in order. Thus, a booklet consisting of a plurality of sheets S is made.

The receiving component 309 is an example of a support member that supports a sheet bundle. The pressing plate 306 is an example of a pressing member that is arranged so as to be opposite to the support member, and by sandwiching the sheet bundle in cooperation with the support member, presses the sheet bundle. The motor 320 drives the pressing member. The counter 514 measures the driving amount of the motor 320 in a period from when the pressing member is in the initial position until it comes into contact with the sheet bundle. The CPU 501 obtains the thickness of the sheet bundle based on a measurement result of the counter 514. The thickness of the sheet bundle B may be obtained based on the driving amount of the motor 320.

The CPU 501 may obtain the thickness of a sheet bundle based on information related to the thickness of the sheet bundle inputted by the user. As indicated in FIG. 10A, the thickness may be inputted by the user or may be computed by the CPU 501 based on the information inputted by the user.

The document reading apparatus 140 reads thickness information (e.g., the barcode 201) printed on a sheet bundle. The CPU 501 obtains the thickness of the sheet bundle based on the read thickness information. The document reading apparatus 140 is an example of a barcode reader.

In the second mode, the target temperature of the heater unit 303 starts to decrease after the pressing plate 306 comes into contact with the sheet bundle B. This reduces the waiting time of the user.

In the first mode, the heating temperature of the heater 304 is kept constant at the first target temperature during the first time. In the second mode, the heating temperature transitions from the first target temperature to the second target temperature during the second time and is then kept constant at the second target temperature. Thus, overheating and insufficient heating is unlikely to occur in both the first mode and the second mode.

Each of a combination of the first target temperature and the first time and a combination of the second target temperature and the second time are determined in advance such that discoloration due to overheating does not occur in the sheet bundle, and a predetermined adhesive strength is ensured. Thus, discoloration and insufficient adhesive strength are unlikely to occur in both the first mode and the second mode.

The heater unit 303 may include the pressing plate 306 to which the heater 304 is attached. This makes it possible to concurrently execute pressing and heating. In particular, a booklet making apparatus that has a simple configuration is provided.

The sheet processing unit 170 may be mounted on or connected to the image forming apparatus 100. The heater 304 is preheated, and thereby the waiting time of the user is reduced. The barcode 201 may be formed on one of the two sheets in the outermost position in the sheet bundle B. This should make it easier for the user to find the barcode 201. Placing the barcode 201 near the adhesive layer should make it easier for the user to recognize which portion of the sheet S should be inserted into the sheet processing unit 170.

The printer 101 changes the position of the adhesive layer each time a predetermined number of sheet bundles are formed. This makes it possible to reduce the wear on the portion of the surface of the printer 101 that comes into contact with the adhesive layer.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-139158, filed August 20, 2024 which is hereby incorporated by reference herein in its entirety.

What is claimed is:

1. A booklet making apparatus comprising:
a receiving unit configured to be manually fed and receive a sheet bundle constituted by a plurality of sheets having an adhesive layer of toner;
a heating unit configured to execute heat processing for heating the adhesive layer in the sheet bundle, which has been manually fed into the receiving unit; and
a pressing unit configured to execute press processing for pressing the adhesive layer in the sheet bundle in parallel with the heat processing by the heating unit.

2. The booklet making apparatus according to claim 1, further comprising:
an accepting unit configured to accept an instruction to start bonding processing for the sheet bundle,
wherein upon acceptance of the start instruction, the heating unit executes the heat processing and the pressing unit executes the press processing.

3. The booklet making apparatus according to claim 1, further comprising:
a detection unit configured to detect the sheet bundle manually fed into the receiving unit,
wherein when the sheet bundle is detected by the detection unit, the heating unit heats the sheet bundle and the pressing unit presses the sheet bundle.

4. The booklet making apparatus according to claim 1, further comprising:
an obtaining unit configured to obtain a thickness of the sheet bundle; and
a control unit configured to control the heating unit and the pressing unit, wherein the control unit includes:
a first mode in which, in a case where the thickness of the sheet bundle is a threshold or below, the heating unit is controlled to be at a first target temperature, and a heating time of the sheet bundle by the heating unit is controlled to be a first time, and
a second mode in which, in a case where the thickness of the sheet bundle exceeds the threshold, the heating unit is controlled to be at a second target temperature, and the heating time of the sheet bundle by the heating unit is controlled to be at a second time, and
the second target temperature is lower than the first target temperature, and the second time is longer than the first time.

5. The booklet making apparatus according to claim 4, wherein
the control unit further includes a third mode in which, by reheating the adhesive layer in the sheet bundle, which has been bonded by toner, by using the heating unit, a sheet is made to be detachable from the sheet bundle, and
in the third mode, the heating unit is controlled to be at a third target temperature, which is higher than the first target temperature.

6. The booklet making apparatus according to claim 1, wherein
when a first sheet bundle is received by the receiving unit, the heating unit heats the first sheet bundle and the pressing unit presses the first sheet bundle, and when a second sheet bundle is stacked on the first sheet bundle in the receiving unit, the heating unit heats the first sheet bundle and the second sheet bundle, and the pressing unit presses the first sheet bundle and the second sheet bundle, and thereby a booklet that includes the first sheet bundle and the second sheet bundle is made.

7. The booklet making apparatus according to claim 4, wherein
the pressing unit includes:
a support member configured to support the sheet bundle,
a pressing member arranged so as to be opposite to the support member, and configured to, by sandwiching the sheet bundle in cooperation with the support member, press the sheet bundle, and
a driving unit configured to drive the pressing member,
the control unit includes:
a measuring unit configured to measure a driving amount of the driving unit in a period from when the pressing member is in an initial position until the pressing member comes into contact with the sheet bundle,
and the obtaining unit obtains the thickness of the sheet bundle based on a measurement result of the measuring unit.

8. The booklet making apparatus according to claim 4, wherein
the obtaining unit obtains the thickness of the sheet bundle based on information related to the thickness of the sheet bundle inputted by a user.

9. The booklet making apparatus according to claim 4, further comprising:
a reading unit configured to read thickness information printed on the sheet bundle,
wherein the obtaining unit obtains the thickness of the sheet bundle based on the thickness information read by the reading unit.

10. The booklet making apparatus according to claim 4, wherein the second mode is a mode in which, when the heat processing of the heating unit on the sheet bundle is started, the heating temperature of the heating unit is decreased from the first target temperature to the second target temperature.

11. The booklet making apparatus according to claim 4, wherein
in the first mode, the heating temperature of the heating unit is kept constant at the first target temperature during the first time, and
in the second mode, the heating temperature transitions from the first target temperature to the second target temperature during the second time and is then kept constant at the second target temperature.

12. The booklet making apparatus according to claim 4, wherein each of a combination of the first target temperature and the first time and a combination of the second target temperature and the second time is determined in advance such that discoloration due to overheating does not occur in the sheet bundle and a predetermined adhesive strength is ensured.

13. The booklet making apparatus according to claim 1, wherein
a total number of sheets constituting a booklet is J sheets, and in a case where a number of sheets that can be bonded in a single instance of the heat processing is K sheets, N sheet bundles are stacked in the receiving unit in order one bundle at a time, and thereby, the heating unit executes the heat processing and the pressing unit executes the press processing on each of the N sheet bundles, and
N is a quotient obtained by dividing J by K.

14. The booklet making apparatus according to claim 1, wherein the heating unit is attached to the pressing unit.

15. An image forming apparatus comprising:
an image forming unit configured to form an adhesive layer on a sheet by using toner;
a booklet making apparatus configured to make a booklet from the sheet
wherein the booklet making apparatus comprises:
a receiving unit configured to be manually fed and receive a sheet bundle constituted by a plurality of sheets having an adhesive layer of toner;
a heating unit configured to execute heat processing for heating the adhesive layer in the sheet bundle, which has been manually fed into the receiving unit; and a pressing unit configured to execute press processing for pressing the adhesive layer in the sheet bundle in parallel with the heat processing by the heating unit.

16. The image forming apparatus according to claim 15, wherein
while the image forming unit is forming the adhesive layer on the sheet, the heating unit starts to generate heat.

17. The image forming apparatus according to claim 15, wherein
the image forming unit forms identification information associated with a heating condition to be applied to the sheet bundle on a sheet that is in an uppermost or lowermost position in the sheet bundle.

18. The image forming apparatus according to claim 17, wherein
the heating condition includes at least one of a heating temperature of the heating unit and a heating time of the heating unit.

19. The image forming apparatus according to claim 15, wherein
the image forming unit forms the adhesive layer on one corner among four corners of the sheet or on a binding margin provided in parallel to a short side or a long side of the sheet.

20. The image forming apparatus according to claim 15, wherein
the image forming unit changes a position of the adhesive layer each time a predetermined number of sheet bundles are formed.
